(19) United States
(12) Patent Application Publication
(10) Pub. No.: US 2007/0006402 A1
(43) Pub. Date: Jan. 11, 2007

(54) Automatic interdental cleaner

(76) Inventor: Young-Han Kang, Jakarta (ID)

Correspondence Address: QUARLES & BRADY LLP, 411 E. WISCONSIN AVENUE, SUITE 2040, MILWAUKEE, WI, 53202-4497, US

(21) Appl. No.: 11/175,768

(22) Filed: Jul. 6, 2005

(51) Int. Cl. A61C 15/00

(52) U.S. Cl. 15/22.1; 132/322

(57) ABSTRACT

An automatic interdental cleaner for cleaning between teeth more effectively and cleanly without hurting the gum between the teeth is disclosed. The cleaner comprises: a grip portion disposed therein with a battery and a motor and a power switch at one wall side; a power transmitting unit coupled to one end of the grip portion for supplying power from the grip portion and formed with a first insertion hole at a free end; an interdental brush portion including a brush holder having a shape corresponding to that of the first insertion hole of the power transmitting unit and also having one end insertedly fixed to the first insertion hole, and a brush fixed to the other end of the brush holder; and an adapter portion one end of which is coupled to the power transmitting unit and the other end of which accepts the interdental brush portion, such that spaces between the teeth can be automatically cleaned using the automatic interdental cleaner.

### CROSS-REFERENCE TO RELATED APPLICATION

Not applicable.

### STATEMENT CONCERNING FEDERALLY SPONSORED RESEARCH OR DEVELOPMENT

Not applicable.

### FIELD OF THE INVENTION

The present invention relates to an automatic interdental cleaner for removing foreign objects between teeth, and more particularly an automatic interdental cleaner adapted to be attached with an interdental brush or an adapter to a grip portion for automatic cleaning between teeth.

### BACKGROUND OF THE INVENTION

Interdental brushes are used as a part of the teeth-cleaning regimen by coupling an end of a handle with a brush or a dental floss. The interdental brushes are useful for removing food remains or dental calculus between teeth where conventional toothbrushes do not touch. They are also useful for cleaning various dental prostheses, such as braces, around various bridgeworks, and improving the level of a person's oral care hygiene.

The interdental brushes thus explained are disclosed in U.S. Pat. No. 5,896,615 granted to Colgate-Palmolive Company.

Interdental brushes according to the prior art will be described with reference to FIGS. 6 and 7. FIG. 6 is a perspective view of an interdental brush according to the prior art, and FIG. 7 is a lateral view of the interdental brush of FIG. 6 removed of an end of a handle.

Referring to FIGS. 6 and 7, an interdental brush 10 is equipped at one end thereof with a handle grip portion 12 with a sloped brush head support portion 14. A brush head cartridge 20 with a brush 22 projecting upwardly therefrom is extended from brush head support portion 14.

A first longitudinal rod section 24 is a part of the brush head attachment means. An aperture 15 on the brush head portion accepts a protrusion on the brush head cartridge 20 to lock the brush head cartridge into the sloped brush head support portion.

At the end of the handle grip portion 12 opposite the brush head portion, there is a movable section 18, which carries a grip 19. This is held in place by a protrusion 34 on a brush head support rod 30 (see FIG. 7), which extends into an aperture 11 of the movable section 18.

In the interdental brushes thus described, after assembled, the handle grip portion 12 can be held by hands and the brush can be manually inserted between teeth. In the interdental brushes according to the prior art, dental floss or thin synthetic resin piece may be inserted between teeth instead of a brush.

However, there is a problem in the interdental brushes thus described according to the prior art in that gums may be hurt by dental floss or thin synthetic resin piece when an excessive force is applied to the gums. There is another problem in that the interdental brushes may not clean between teeth in the desired state due to inattention by a user.

### SUMMARY OF THE INVENTION

The present invention is disclosed to solve the aforementioned problems and it is an object of the present invention to provide an automatic interdental cleaner adapted not to hurt gums between teeth and to effectively clean between the teeth as well.

In accordance with the object of the present invention, the automatic interdental cleaner is provided, the cleaner comprising: a grip portion disposed therein with a battery and a motor and a power switch at one side wall; a power transmitting unit coupled to one end of the grip portion for supplying power from the grip portion and formed with a first insertion hole at a free end; and an interdental brush portion including a brush holder having a shape corresponding to that of the first insertion hole of the power transmitting unit and also having one end insertedly fixed to the first insertion hole, and a brush fixed to the other end of the brush holder.

The automatic interdental cleaner further comprises an adapter portion one end of which is coupled to the power transmitting unit and the other end of which accepts the interdental brush portion.

The adapter comprises: a connecting portion surrounded on a peripheral surface of the power transmitting unit and disposed at a lateral wall thereof with a fixing hook meshing with the power transmitting unit; an extension portion extended from the connecting portion; and an interdental brush holder disposed at one end thereof with a second insertion hole having a shape corresponding to that of the end of the brush holder.

The interdental brush holder is slantly connected at a predetermined angle relative to the extension portion.

The interdental brush holder is inclined at 80-120 degrees relative to the extension portion, and more preferably, at 90-100 degrees.

The second insertion hole may be of a cylindrical or a plate shape at one end thereof.

### BRIEF DESCRIPTION OF THE DRAWINGS

The accompanying drawings illustrate preferred embodiments of the present invention and are a part of the specification. Together with the following description, the drawings demonstrate and explain the principles of the present invention. The illustrated embodiments are examples of the present invention and do not limit the scope of the invention.

FIG. 1 a perspective view for schematically illustrating an automatic interdental cleaner according to a first embodiment of the present invention;

FIG. 2 is a perspective view for illustrating an interdental brush portion of FIG. 1;

FIG. 3 is a perspective view for schematically illustrating an automatic interdental cleaner according to a second embodiment of the present invention;

FIG. 4 is a plan of an adapter portion of FIG. 3;

FIG. 5 is a lateral of the adapter portion of FIG. 3;

FIG. 6 is a perspective view of an interdental brush according to the prior art; and

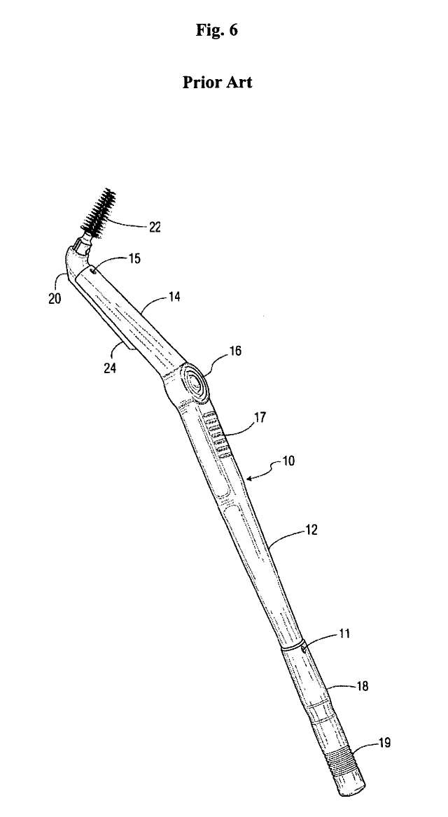

FIG. 7 is a lateral view removed of an end of a handle at the interdental brush of FIG. 6.

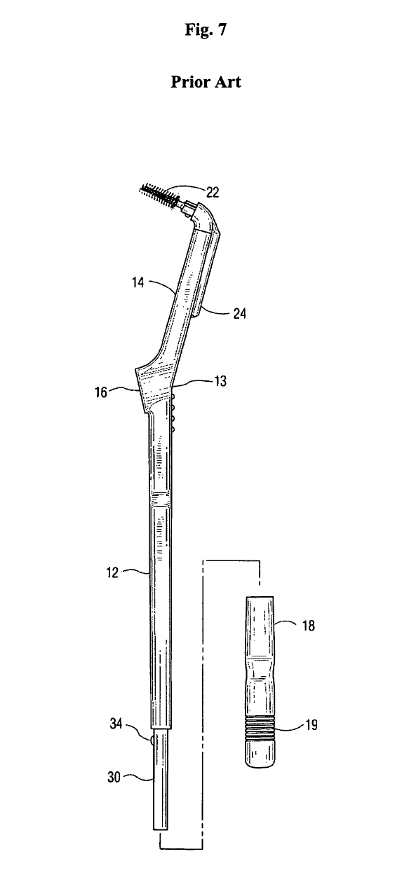

### DETAILED DESCRIPTION OF THE INVENTION

The automatic interdental cleaner according to the preferred embodiments of the present invention will now be described in detail with reference to the annexed drawings.

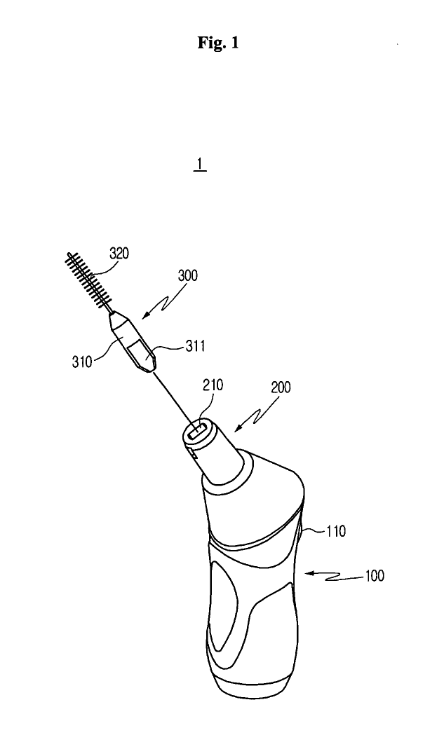

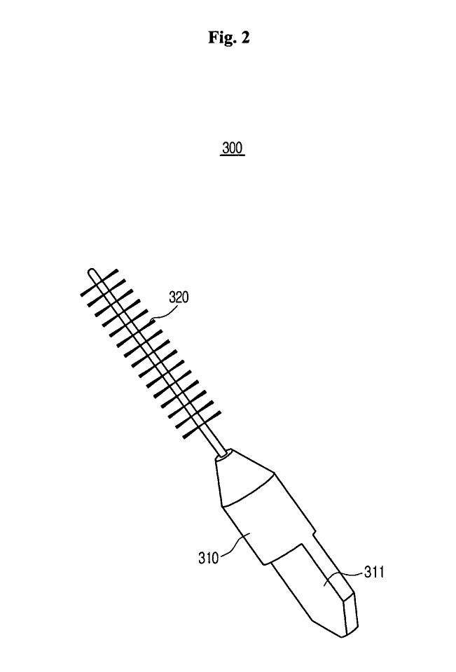

FIG. 1 is a perspective view for schematically illustrating an automatic interdental cleaner 1 according to a first embodiment of the present invention and FIG. 2 is a perspective view of an interdental brush portion 300 of FIG. 1.

Referring to FIG. 1, an automatic interdental cleaner 1 according to the first embodiment of the present invention includes a grip portion 100, a power transmitting unit 200 and an interdental brush portion 300.

The grip portion 100 is disposed therein with a battery (not shown) and a motor (not shown). The grip portion 100 is disposed at one lateral wall thereof with a power switch 110 that is circuitally connected to the battery (not shown) and the motor (not shown).

The power transmitting unit 200 is cylindrically shaped and coupled to one end of the grip portion 100. The power transmitting unit 200 receives the power from the motor (not shown) formed inside the grip portion 100 on switching and vibrates thereby.

A free end of the power transmitting unit 200 is formed with a first insertion hole 210 which, as shown in FIG. 1, has a rectangular plate shape but may carry a variety of shapes like cylindrical shape, spiral shape and the like.

The interdental brush 300 includes a brush holder 310 whose one end is fixedly inserted into the first insertion hole 210 and a brush 320 that is fixed to the other end of the brush holder 310.

Referring to FIG. 2, the brush holder 310 has a plate shape at one end 311 thereof. The one end 311 of the brush holder 310 has a shape corresponding to that of the first insertion hole 210 so as to be inserted into the first insertion hole 210 formed at the power transmitting unit 200. For that reason, in case the first insertion hole 210 has a cylindrical shape or a spiral shape, the one end of the brush holder 310 is to subsequently have a shape corresponding to that of the first insertion hole 210.

The brush holder 310 has a cylindrical shape at the other end thereof to which the brush 320 is fixed. The brush holder 310 may be made of resilient material like rubber or synthetic resin material.

Hereinafter, the operation of the automatic interdental cleaner according to the first embodiment of the present invention will be described.

First of all, the first insertion hole 210 at the power transmitting unit 200 is inserted by the one end 311 of the brush holder at the interdental brush portion 300. Because the shape of the first insertion hole 210 and that of the one end of the brush holder 311 are correspondingly matched, the interdental brush portion 300 is fixed in the first insertion hole 210 when the one end 311 of the brush holder is inserted into the first insertion hole 210.

Thereafter, when the power switch 110 is pressed, the motor (not shown) disposed inside the grip portion 100, which is circuitally connected to the power switch 110 is vibrated. The vibration of the motor (not shown) is transmitted to the power transmitting unit 210, and the vibration of the power transmitting unit 210 is in turn transmitted to the interdental brush portion 300.

When the vibrating brush 320 is inserted between teeth, food remaining or tartar between the teeth can be automatically removed. The gum contacting the interdental brush portion 300 is not hurt because the brush 320 is soft.

When the cleaning between the teeth is over and the brush 320 is removed from between the teeth and the power switch 110 is turned off, the vibration is stopped. Following the completion of the vibration, the interdental brush 300 is separated from the first insertion hole 210, cleansed and stored.

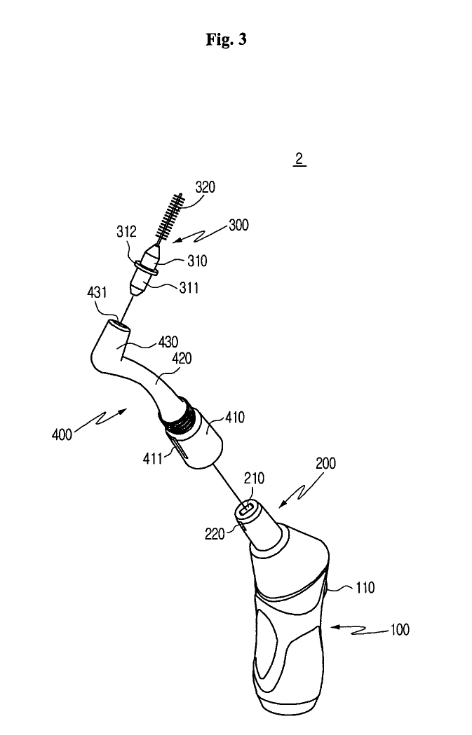

Now, referring to FIGS. 3 to 5, the automatic interdental cleaner according to the second embodiment of the present invention will be described. The same reference numerals refer to the same parts or portions throughout the various figures, and explanation of the same elements will be briefed.

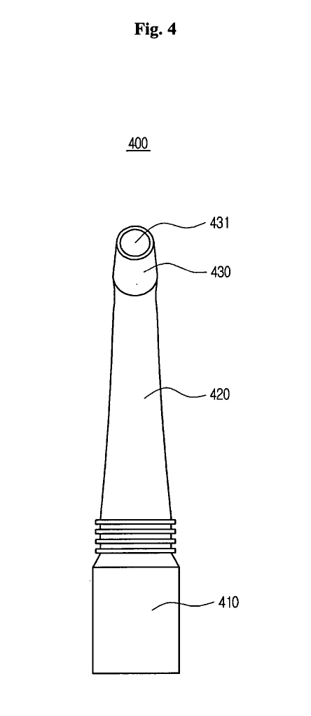

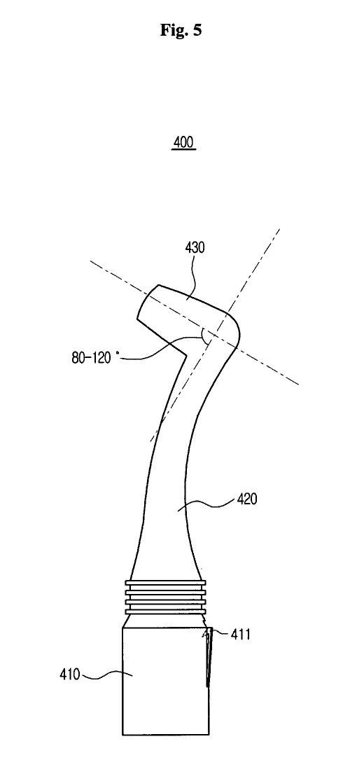

FIG. 3 is a perspective view for schematically illustrating an automatic interdental cleaner according to a second embodiment of the present invention, FIG. 4 is a plan view of an adapter portion 400 of FIG. 3, and FIG. 5 is a lateral view of the adapter portion 400 of FIG. 3.

Referring to FIG. 3, an automatic interdental cleaner 2 according to the second embodiment of the present invention includes a grip portion 100, a power transmitting unit 200, an interdental brush portion 300 and an adapter portion 400.

The grip portion 100 is disposed therein with a battery (not shown) and a motor (not shown). The grip portion 100 is disposed at one lateral wall thereof with a power switch 110 that is circuitally connected to the battery (not shown) and the motor (not shown).

The power transmitting unit 200 is cylindrically shaped and coupled to one end of the grip portion 100. The power transmitting unit 200 receives the power from the motor (not shown) formed inside the grip portion 100 and vibrates thereby. The power transmitting unit 200 is formed at one lateral wall thereof with an aperture 220.

The interdental brush portion 300 includes a brush holder 310 for insertion into the adapter portion 400, and a brush 320 fixed to the other end of the brush holder 310. One end 311 of the brush holder 310 may be cylindrical as shown in FIG. 3, or may be of plate shape as shown in FIGS. 1 and 2. The end 311 may carry a variety of shapes.

The adapter portion 400 is coupled at one end thereof to the power transmitting unit 200, and the other end of the adapter portion 400 receives the interdental brush portion 300.

Now, the adapter portion 400 will be described in detail with reference to FIGS. 4 and 5.

The adapter portion 400 comprises a connecting portion 410, an extension portion 420 and an interdental brush holder 430.

The connecting portion 410 is surrounded on the peripheral surface of the cylindrical power transmitting unit 200. The connecting portion 410 is disposed at one lateral wall thereof with a fixing hook 411 that is hitched at the aperture 220 of the power transmitting unit 200. The fixing hook 411 is inserted into the aperture 220 to prevent the adapter portion 400 from rotating or being bolted.

The extension portion 420 extended from the connecting portion 410 has a predetermined curved or axial shape. The extension portion 420 may be integrally formed with the connecting portion 410, or may be glued or screwed to the connecting portion 410.

The interdental brush holder 430 is connected to an opposite side of the extension portion 420 that is in turn connected to the connecting portion 410. The interdental brush holder 430 is integrally formed with the extension portion 420 and is formed at one end thereof with a second insertion hole 431, the shape of which corresponds to that of the end 311 of the brush holder 310.

The second insertion hole 431 may have a cylindrical shape corresponding to that of the end 311 of the brush holder 310 as shown in FIGS. 3 and 4, but may carry a variety of shapes such as plate shape, screw shape and the like.

In case the end 311 of the brush holder 310 is cylindrical, an annular support plate 312 may be integrally formed with the midsection of the brush holder 310 for preventing the brush holder 310 from entering an interior of the second insertion hole 431 of the interdental brush holder 430.

The interdental brush holder 430 may be slantly connected to the extension portion 42 at a predetermined angle. The angle between the interdental brush holder 430 and the extension portion 420 is generally set at 80-120 degrees. Preferably, the angle between the interdental brush holder 430 and the extension portion 420 is given at 90-100 degrees. These angles are within an angle scope in which the brush 320 is conveniently and ergonomically positioned between teeth, when the grip portion 100 is held by a user.

Hereinafter, the operation of the automatic interdental cleaner according to the second embodiment of the present invention will be described.

First, an outside of the power transmitting unit 200 is fitted into by the connecting portion 410 of the adapter portion 400. The fixing hook 411 is made to get hitched at the aperture 220 of the power transmitting unit 200 to fix the adapter portion 400 and the power transmitting unit 200.

Thereafter, the interdental brush portion 300 is inserted into the second insertion hole 431 of the adapter portion 400. The brush holder 310 of the interdental brush portion 300 matches the shape to that of the second insertion hole 431 of the interdental brush holder 430 such that, when the second insertion hole 431 is inserted by the end 311 of the brush holder, the interdental brush portion 300 is fixed at the adapter portion 400.

Afterward, when the power switch 110 is pressed, the motor (not shown) disposed inside the grip portion 100 circuitally connected to the power switch 110 is vibrated. The vibration of the motor (not shown) is transmitted to the power transmitting unit 200, and vibration of the power transmitting unit 200 is in turn transmitted to the interdental brush portion 300.

When the vibrating brush 320 is inserted between teeth, food remains or tartar between the teeth can be automatically removed by the vibration. The gum contacting the interdental brush portion 300 is not hurt at all because the brush 320 is soft.

In the automatic interdental cleaner 2 according to the second embodiment of the present invention, the adapter portion 400 is separately attached to the power transmitting unit 200 such that many spaces near molar teeth that the brush 320 alone cannot penetrate can be easily cleaned. Furthermore, the extension portion 420 and the interdental brush holder 430 are inclined each at a predetermined angle, the teeth can be ergonomically cleaned at a convenient position.

The power transmitting unit 200 of the automatic interdental cleaner 2 according to the second embodiment of the present invention is formed at a free end thereof with the first insertion hole 210 as in the automatic interdental cleaner 1 of the first embodiment. If the shape of the first insertion hole 210 and that of the second insertion hole 431 are the same, the interdental brush portion 300 may be inserted into either the first insertion hole 210 or the second insertion hole 431 as needed and required by a user.

Once the cleaning is over between the teeth, the brush 320 is removed from between the teeth, and the power switch 110 is turned off to stop the vibration. When the vibration is stopped, the interdental brush portion 300 and the adapter portion 400 are separated from the power transmitting unit 200, and cleaned and stored for after-use.

As apparent from the foregoing, there is an advantage in the automatic interdental cleaner thus described according to the embodiments of the present invention in that a soft brush is used to reduce the possibility of the gum being hurt. There is another advantage in that food remains or tartar can be automatically cleaned between teeth to increase a cleaning efficiency.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. An automatic interdental cleaner comprising:
a grip portion disposed therein with a battery and a motor and a power switch at one wall side;
a power transmitting unit coupled to one end of the grip portion for supplying power from the grip portion and formed with a first insertion hole at a free end; and
an interdental brush portion including a brush holder having a shape corresponding to that of the first insertion hole of the power transmitting unit and also having one end insertedly fixed to the first insertion hole, and a brush fixed to the other end of the brush holder.

2. The cleaner as defined in claim 1 further comprising an adapter portion one end of which is coupled to the power transmitting unit and the other end of which accepts the interdental brush portion.

3. The cleaner as defined in claim 2, wherein the adapter comprises:
a connecting portion surrounded on a peripheral surface of the power transmitting unit and disposed at a lateral wall thereof with a fixing hook meshing with the power transmitting unit;
an extension portion extended from the connecting portion; and
an interdental brush holder disposed at one end thereof with a second insertion hole having a shape corresponding to that of the end of the brush holder.

4. The cleaner as defined in claim 3, wherein the interdental brush holder is slantly connected at a predetermined angle relative to the extension portion.

5. The cleaner as defined in claim 4, wherein the interdental brush holder is inclined at 80-120 degrees relative to the extension portion.

6. The cleaner as defined in claim 4, wherein the interdental brush holder is inclined at 90-100 degrees relative to the extension portion.

7. The cleaner as defined in claim 3, wherein the second insertion hole is cylindrical.

8. The cleaner as defined in claim 3, wherein the second insertion hole has a plate shape.
